(19) United States
(12) Patent Application Publication
(10) Pub. No.: US 2025/0342054 A1
(43) Pub. Date: Nov. 6, 2025

(54) ORCHESTRATION OF AI MODEL DEPLOYMENT ON MULTI-GPU SYSTEMS

(71) Applicant: NVIDIA Corporation, Santa Clara, CA (US)

(72) Inventors: Shekhar Dwivedi, Santa Clara, CA (US); Rahul Choudhury, Livermore, CA (US); Mahdi Azizian, San Jose, CA (US)

(21) Appl. No.: 18/655,011

(22) Filed: May 3, 2024

(51) Int. Cl. G06F 9/50; G06F 13/42

(52) U.S. Cl. CPC G06F 9/5016; G06F 9/505; G06F 9/5072; G06F 13/4282; G06F 2213/0026

(57) ABSTRACT

Apparatuses, systems, and frameworks for provisioning of efficient pipelines capable of multi-model inference and data processing using multiple processing units, including streaming data applications. The disclosed techniques include, during an initialization stage, assigning a plurality of machine learning models (MLMs) for execution on graphics processing units (GPUs), allocating memory space, on a hub GPU, to the plurality of MLMs, storing input data on the hub GPU before transferring the input data to other GPUs for execution. During an execution stage, output data is initially stored on GPUs that generated the output data before transferring the output data to the hub GPU.

### TECHNICAL FIELD

At least one embodiment pertains to processing resources used to perform and facilitate artificial intelligence. For example, at least one embodiment pertains to efficient deployment of machine learning models using multiple graphics processing units (GPUs).

### BACKGROUND

Artificial intelligence (AI), including machine learning, is often used in many settings, such as office and hospital environments, medical imaging, robotic automation, security applications, autonomous transportation, law enforcement, among others. In particular, machine learning has applications in audio and video processing, such as in voice, speech, and object recognition. One popular approach to machine learning involves training a computing system using training data (sounds, images, actions, face expressions, texts, and/or other data) to identify patterns in the data that may facilitate data classification, such as the presence of a particular type of an object within a training image or a particular word within a training speech or text. Training can be supervised or unsupervised. Machine learning models can use various computational algorithms, such as decision tree algorithms (or other rule-based algorithms), artificial neural networks, and the like. After a deployment of a successfully trained machine learning model, new data is input into the trained machine learning model during an inference stage and various target objects, sounds, sentences, actions, an/or any other target patterns can be identified using patterns and features learned during training.

### BRIEF DESCRIPTION OF DRAWINGS

FIG. 1A is a block diagram of an example architecture of a computing system that supports multi-model multi-processor inference and data processing, according to at least one embodiment;

FIG. 1B illustrates an example inference server capable of supporting multi-model multi-processor inference and data processing, according to at least one embodiment;

FIG. 2 illustrates a processing pipeline for multi-model inference and data processing using multiple GPUs, according to at least one embodiment;

FIG. 3A illustrates operations of an initialization stage of a multi-model multi-GPU inference, according to at least one embodiment;

FIG. 3B illustrates operations of an execution stage of the multi-model multi-GPU inference, according to at least one embodiment;

FIG. 4A illustrates schematically a process of assigning models to GPUs and allocating memory spaces for various models, as part of initialization stage of a multi-model multi-GPU inference, according to at least one embodiment;

FIG. 4B illustrates schematically a process of loading input data into a memory space allocated on a hub GPU, as part of execution stage of a multi-model multi-GPU inference, according to at least one embodiment;

FIG. 4C illustrates schematically a process of transferring input data into memory spaces of the assigned GPUs, according to at least one embodiment;

FIG. 4D illustrates schematically a process of populating assigned memory spaces with outputs of models, according to at least one embodiment;

FIG. 4E illustrates schematically a process of transferring outputs to the hub GPU, according to at least one embodiment;

FIG. 4F illustrates schematically a process of transferring outputs from the hub GPU to a host, according to at least one embodiment;

FIG. 5 is a flow diagram of an example method of performing an initialization stage of a multi-model AI processing using multiple GPUs, according to at least one embodiment;

FIG. 6 is a flow diagram of an example method of performing an execution stage of a multi-model AI processing using multiple GPUs, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment;

FIG. 10 is a system diagram for an example system for training, adapting, instantiating and deploying machine learning models in an advanced computing pipeline, according to at least one embodiment.

### DETAILED DESCRIPTION

Machine learning (ML) is extensively used in a constantly growing number of technological areas and industries where at least some levels of decision-making can be delegated to automated computer processing. Machine learning models (MLMs) quickly become more adept in execution of increasingly sophisticated tasks. Often, a pipeline of multiple MLMs is used to process large amounts of complex data, including streaming data. For example, medical imaging data—such as computer tomography (CT) data, magnetic resonance imaging (MRI) data, and so on—may include one or more large medical images of a patient's body. One MLM may be trained to crop the large image into smaller images that depict individual organs, e.g., heart, lungs, abdominal cavity, and/or the like. The cropped images may be processed by multiple individual MLMs trained to perform inference for a particular organ. The MLMs may diagnose the presence of various pathologies of organs depicted in the respective cropped portions and output inference predictions (classifications), such as types, locations, and severity of the discovered pathologies. A separate MLM may use, as input, the combined organ-level inference predictions generated by corresponding MLMs and output a likely diagnosis (or multiple diagnoses) of the patient's ailments and, possibly, suggest one or more treatment options. Such a patient-level inferencing may further be based on additional inputs, such as medical records of the patient, a natural language description of patient's current self-assessment and/or complaints, and/or the like.

The multiple deployed MLMs may have different architectures and computational complexities. Some MLMs may include convolutional neural networks (NNs) trained to process images, other MLMs may include recurrent NNs or transformer NNs trained to process a time series of laboratory test results, yet other MLMs may deploy conversational language (e.g., transformer-based) technology trained to process verbal or textual inputs, and/or the like. Operations of the deployed MLMs may be executed on one or more processing devices, e.g., GPUs. Since GPUs allow parallel execution of a large number of processing threads (each performing a portion of matrix multiplications and/or other similar computations), GPUs are increasingly selected as the top choice for MLM and NN processing. A number and complexity of multiple MLMs that are executed concurrently, e.g., in parallel, in conjunction with a given task often calls for use of multiple GPUs. Furthermore, some GPUs (alone or in coordination with one or more central processing units, CPUs) may have to perform numerous additional functions. For example, input images (e.g., large or cropped images) may undergo a variety of pre-processing operations, e.g., denoising, enhancement, adjustment of contrast and resolution (e.g., downsampling or upsampling), and/or the like. The data generated by the inference processing may still be post-processed, e.g., combined with images, annotated with texts, supplied with dimensions, augmented with references to suggested diagnoses, treatments, and/or recommended testing procedures, represented in a form suitable or convenient for viewing by a human specialist, and/or the like.

Coordinating efficient execution of pre-processing, inference, and post-processing on systems with multiple GPUs is an important but very challenging task. Complexity of multi-GPU execution arises from the need to allocate execution of individual MLMs on various GPUs, configure data transfer between MLMs and between different GPUs, between inference operations and various pre-processing and/or post-processing operations, between multiple GPUs and a host (e.g., a CPU-executed application), and/or the like. Presently, configuring, deploying, and executing multiple MLMs on multiple GPUs requires significant expertise in coding and efficient utilization of hardware resources and further requires knowledge of AI architecture and run-time processing. More specifically, a developer typically has to write code implementing data traffic for each MLM and each GPU, including specifying allocation of memory buffers for input data and output data of various models. Additional, typically high-complexity code may need to be written with detailed instructions about controlling handling of the input data (e.g., delivered from the pre-processing stage) and the output data (e.g., provided to the post-processing stage). Optimizing such memory allocation and data transfers to minimize latency and improving efficiency of the GPU utilization is a challenging task, even for experienced developers.

Aspects and embodiments of the present disclosure address these and other challenges of the modern AI deployment technology by providing for methods and systems that facilitate inference processing of data (including streaming data) using multiple MLMs that are executed on multiple GPUs. In one or more embodiments, the multiple GPUs may correspond to the GPUs in a single processing node or cluster. In some embodiments, deployment of MLMs may include an initialization stage and an execution stage. During the initialization stage, a user may select a set of parameters for MLM execution. The set of parameters may include an input data map, which specifies memory locations storing inputs into various MLMs, e.g., outputs of the pre-processing stage. The set of parameters may further include an output data map, which specifies memory locations to store outputs of various MLMs. The set of parameters may also include a device map that specifies mapping of MLMs to various GPUs, with individual GPUs executing one or more MLMs. In some implementations, the set of parameters may also identify a GPU to serve as a data transfer GPU, referred to as a hub (or “first”) GPU (GPU-0) herein, that manages for data transfers. More specifically, responsive to receiving the set of parameters specifying execution of N MLMs, referred to simply as models herein for brevity, e.g., Model-1 . . . Model-N, an inference engine performing the initialization stage may designate the hub GPU as the recipient of input data for all N models. Correspondingly, the inference engine may allocate memory space for each model in the memory of the hub GPU. The memory allocation may be performed based on the size of the expected inputs (which may be known from architecture of the individual models). Additionally, the inference engine may allocate memory space, on each of M additional GPUs designated (e.g., in the received set of parameters) to execute corresponding models. For example, the hub GPU may be designated to execute Model-1, Model-3 and Model-6, whereas a second GPU (GPU-1) is designated to execute Model-5, and a third GPU (GPU-2) is designated to execute Model-2 and Model-4. Correspondingly, memory space for Model-1, Model 3, and Model-6 may be allocated on the hub GPU (GPU-0) whereas memory space for Model-5 may be allocated both on the hub GPU (GPU-0) and second GPU (GPU-1) and memory space for Model-2 and Model-4 may be allocated on the hub GPU and third GPU (GPU-2). Likewise, the inference engine may allocate memory space for the outputs of various models. The allocation of the memory space for the outputs may be performed on the same GPUs that is to execute the respective models and also on the hub GPU. In the above example, memory space for storing outputs of Model-1, Model-3, and Model-6 may be allocated in the local memory of the hub GPU, memory space for storing outputs of Model-5 may be allocated both in the local memories of the second (GPU-1) and the hub GPU, and outputs of Model-2 and Model-4 may be allocated in the local memories of the third GPU (GPU-2) and the hub GPU.

During an execution stage, a pre-processing engine, which may be responsible for preparing the input data in a format that can be used by the models (e.g., cropping, enhancing, rescaling, and normalizing the input images), may initially store the input data in the memory space of the hub GPU. Subsequently, the inference engine may transfer the data from the memory space of the hub GPU to the other memory space(s) of one or more of the other GPUs. More specifically, after GPU-1 has finished execution of Model-5 and has stored the outputs of Model-5 in the memory space allocated on GPU-1, the inference engine may transfer the output of Model-5 from the memory space of GPU-1 to the memory space of the hub GPU (allocated for the same model). After all GPUs (e.g., GPU-1 . . . GPU-M) have finished execution of the models running thereon and transferred the output data to the hub GPU, the hub GPU can transfer that data (together with the output data generated by the models executed directly on the hub GPU) to a post-processing engine, which may be executed using a different GPU, a CPU, or some other processing device or a combination of processing devices.

The advantages of the disclosed systems and techniques are in the optimization of data transfer into and out of the bank of GPUs and reduction of the latency of AI processing. In conventional multi-GPU systems, a host CPU would need to load each the model (parameters of various layers of the model) on a respective GPU at initialization time and then load input data and fetch output data separately to and from each GPU, resulting in an extra time spent on CPU switching between different GPUs. In those instances where inference is performed at runtime, e.g., with MLMs processing input data at a rate of 30 frames per second (fps), 60 fps, or more, the accumulated delay may be significant. In contrast, the disclosed systems and techniques efficiently reduce the latency associated with host switching between different GPUs by making one GPU (the hub GPU) responsible for data transfers to, from, and inside the bank of GPUs.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

The systems and techniques disclosed herein are particularly advantageous in situations of real-time inference where collecting data for subsequent offline processing is not viable, e.g., in applications where data arrives at a high rate (e.g., 60 fps, for video data processing) and the processing of each frame of data has to be completed—e.g., by multiple models inferencing the same data—before processing of a subsequent frame commences. In such applications, a small per-frame delay (e.g., a millisecond) may nonetheless accumulate very quickly over multiple frames and cause significant delays and degraded performance. The disclosed embodiments eliminate such delays and improve efficiently of inference processing.

Disclosed embodiments may be comprised in a variety of different systems such as automotive systems (e.g., a control system for an autonomous or semi-autonomous machine, a perception system for an autonomous or semi-autonomous machine, an in-vehicle infotainment system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) or visual language models (VLMs) that may process text, voice, image, and/or other data types to generate outputs in one or more formats, systems implemented at least partially using cloud computing resources, systems for performing generative AI operations, and/or other types of systems.

### System Architecture

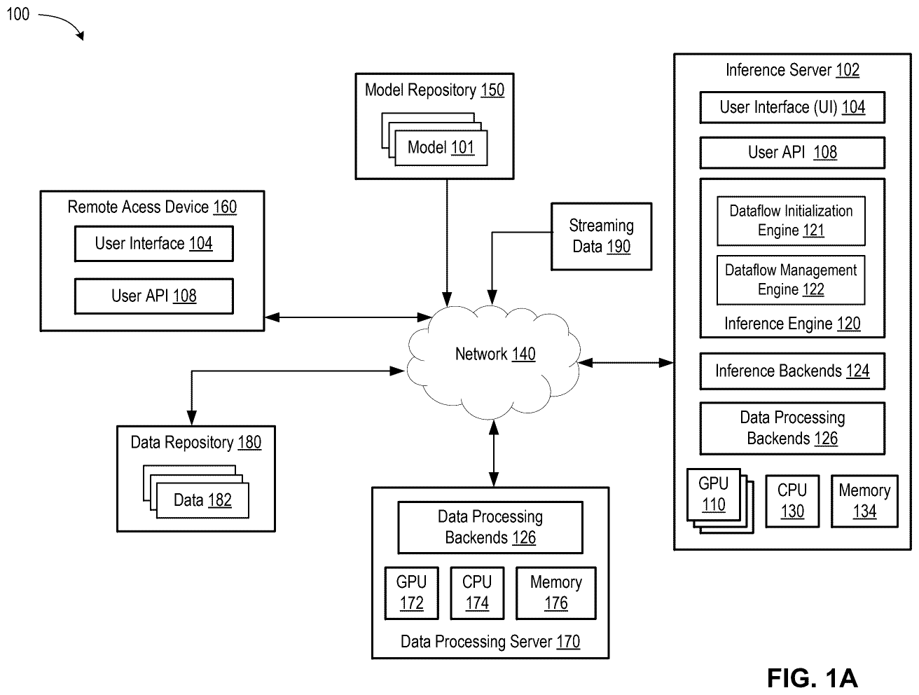

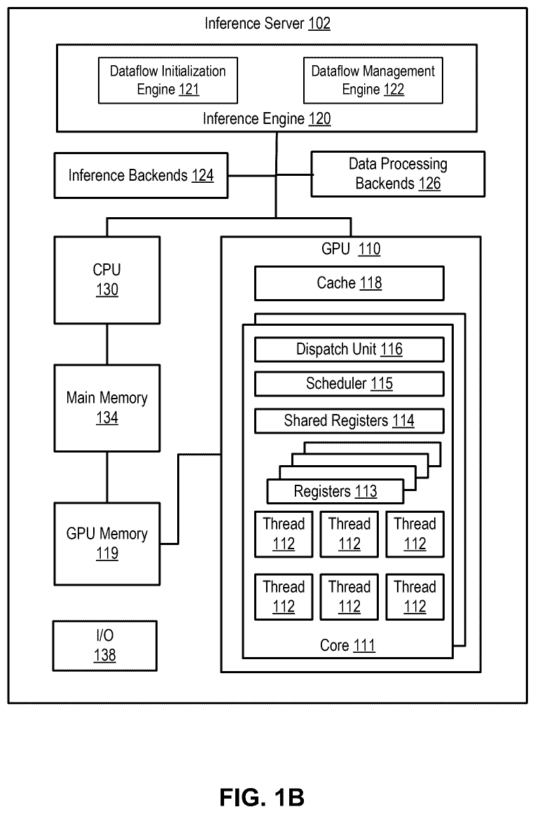

FIG. 1A is a block diagram of an example architecture 100 of a computing system that supports multi-model multi-processor inference and data processing, according to at least one embodiment. Although, for concreteness, references in this disclosure are often made to GPUs, the disclosed techniques may also be used to optimize dataflow in AI processing using multi-processor systems of other types, e.g., systems deploying parallel processing units (PPUs), data processing units (DPUs), and/or the like. As depicted in FIG. 1A, example architecture 100 may be implemented on multiple computing devices, e.g., inference server 102, remote access device 160, data processing server 170, and the like, and may use multiple storage repositories, including but not limited to a model repository 150 and data repository 180. Any of the servers, storages, modules, and components of example architecture 100 may be implemented using cloud computing. In some embodiments, any of the modules and components of example architecture 100 may be implemented using more or fewer devices than are shown in FIG. 1A. In some embodiments, any, some, or all modules and components of example architecture 100 may be implemented on a single computing device (e.g., inference server 102), including but not limited to a computing device local to a user of example architecture 100.

Inference server 102 may be or include a desktop computer, a laptop computer, a smartphone, a tablet computer, a server, a computing device that accesses a remote server, a computing device that utilizes a virtualized computing environment, a gaming console, a wearable computer, a smart TV, and/or any combination thereof. A user may have a local or remote (e.g., over a network) access to inference server 102. For example, the user may access inference server 102 via a remote access device 160, which may be any type of computing device referenced above in conjunction with inference server 102, or any other type of computing device, or a combination of multiple computing devices. Inference server 102 may have any number of GPUs 110, CPUs 130, PPUs, DPUs, or accelerators, and/or other suitable processing devices capable of performing the techniques described herein. GPU 110 and/or CPU 130 may support any number of virtual CPUs and/or virtual GPUs. Inference server 102 may include any number of memory devices, also referred to simply as memory 134 herein. Inference server 102 may also include network controllers, peripheral devices, and the like. Peripheral devices may include cameras (e.g., video cameras) for capturing images (or sequences of images), microphones for capturing sounds, scanners, sensors, or any other devices for intake of data.

In some embodiments, inference server 102 may include a number of engines and components to facilitate efficient multi-model inference and data processing. A user (customer, end user, developer, data scientist, etc.) may interact with inference server 102 via a user interface (UI) 104, which may include a command line, a graphics-based UI, a web-based UI (e.g., a web browser-accessible interface), a mobile application-based UI, or any combination thereof. UI 104 may display menus, tables, graphs, flowcharts, graphical and/or textual representations of software, dataflows, and workflows. UI 104 may include selectable items, which may allow the user to enter various configuration settings, identify models to be deployed, a number and type of GPUs to be used for execution of the models, locations of input data to be processed, and/or destinations for output data, and so on. User actions and configuration settings entered via UI 104 may be communicated to inference engine 120 via a user API 108. In some embodiments, UI 104 and user API 108 may be located on remote access device 160 that the user is using to access inference engine 120. For example, API package with user API 108 and/or user interface 104 may be downloaded to remote access device 160. The downloaded API package may be used to install user API 108 and/or user interface 104 to enable the user to have bilateral communication with inference engine 120.

User API 108 may provide to the user a set of high-level commands that can be understood by inference engine 120 as instructions to deploy multiple user-specified models 101 (also referred to as MLMs herein) and use the deployed models to evaluate data, which may include data 182 stored in data repository 180 and/or streaming data 190, e.g., data generated at runtime by any sensors, such as imaging sensors, video sensors, audio sensors, physical sensors, chemical sensors, and/or any other suitable sensors, and/or combinations thereof. The high-level commands, made available via user API 108, may include commands that identify locations where models 101 are stored (or temporarily held), commands that identify where data to be input into models 101 is stored or originated (e.g., in case of data streaming), and commands that indicate specific backends to be used with various models. The high-level commands may further include identification of a number format to be used during inference computations (e.g., integer, half-precision, full precision format, etc.), execution modes (e.g., parallel processing, batch processing, multi-GPU processing), and/or the like. The high-level commands may specify how data is to be moved along a processing pipeline (e.g., input→pre-processing→inference→post-processing→storage/streaming pipeline), and where the end user of the output data may be located.

Individual high-level commands may be selected by the user using statements native to the user API 108. Individual high-level commands may include an operation code recognizable by inference engine 120 as a request to compile a set of low-level commands to perform one or more user-selected operations. Individual high-level commands may further include one or more parameters specifying how the user-intended operations are to be performed. Compiling the set of operations may include selecting, by inference engine 120, one or more pluggable backends for performing the user-selected operations. Inference engine 120 may configure execution of the backends on one or more processing devices (e.g., GPUs 110, CPUs 130, etc.), which may be default processing devices, processing devices selected by inference engine 120, or user-selected processing devices. Some of the high-level commands may cause inference server 102 to configure transfer of data through the processing pipeline, including allocating memory for input data, fetching input data, pre-processing input data, identifying input data shared by multiple models 101 (to avoid storage of multiple copies of the same data), storing inference outputs of models 101, allocating memory for the inference outputs and for final outputs, directing the final outputs to the ultimate consumers of those final outputs, and/or the like.

In some embodiments, the user-selected commands may include configuration inputs that specify a number of GPUs 110 to be used for execution of various models 101 and indicate models 101 to be executed using specific GPUs 110. The configuration inputs may specify memory locations for storing inputs and outputs of various models 101. Implementation of the configuration inputs may be performed by one or more sub-engines of inference engine 120, e.g., a dataflow initialization engine 121 and a dataflow management engine 122. Dataflow initialization engine 121 may identify a GPU to serve as hub GPU and mediate data transfer to and from individual GPUs 110. Dataflow initialization engine 121 may further allocate memory space on the hub GPU and various individual GPUs to store inputs and outputs of various models 101. Dataflow management engine 122 may load specific models 101 and input data for the models into memory spaces allocated by dataflow initialization engine 121. For example, dataflow management engine 122 may initially load input data into memory space of the hub GPU and subsequently move the input data into memory spaces of the individual GPUs, for execution of those models that are to be run on individual GPUs other than the hub GPU. Following completion of model execution, dataflow management engine 122 may store outputs of models 101 on individual GPUs before moving the outputs to the hub GPU and further move the outputs to a host or one or more data processing backends.

Backends should be understood as any software resources, packages, toolkits, software development kits (SDKs), which are capable of executing on suitable hardware, including but not limited to one or more GPUs 110, one or more CPUs 130, and any other processing resources. Individual backends may include executable codes, libraries, and configuration files. Backends may include inference backends 124 that perform inference on input data using models 101. Backends may further include data processing backends 126 that should be understood as any software tools performing any processing of data different from model-based inference. Data processing backends 126 may include pre-processing backends and post-processing backends. For example, pre-processing backends may perform any processing of the input data, such as denoising, enhancement, changing resolution and contrast, binarization, cropping, aggregation, re-formatting, de-archiving, compression, and/or the like. Post-processing backends may perform any processing of data that occurs after inference, such as annotation of data, pagination of data, combining data, reformatting of data, compression of data, streaming of data, augmentation of data with other data, including augmentation with data generated by other models 101 and/or auxiliary data, and/or the like.

In some embodiments, at least some of the functionality of inference server 102 may be supported by (e.g., split between) multiple computing devices. For example, as depicted in FIG. 1A, data processing backends 126 may be located on a separate data processing server 170 and may utilize additional and separate processing and memory resources, e.g., one or more CPU(s) 172, GPU(s) 174, and memory devices 176.

Models 101 may be pre-trained and stored on inference server 102 or in model repository 150 accessible to inference server 102 over a network 140. Network 140 may be a public network (e.g., the Internet), a private network (e.g., a local area network (LAN), or wide area network (WAN)), a wireless network, a personal area network (PAN), or a combination thereof. Models 101 may include regression algorithms, decision trees, support vector machines, K-means clustering models, neural networks, or any other machine learning algorithms. Neural network MLMs may include convolutional, recurrent, fully-connected, Long Short-Term Memory models, Hopfield networks, Boltzmann networks, attention-based models, transformer models, conformer models, and/or any other types of models. Generating MLMs may include setting up an MLM type (e.g., a neural network), architecture, a number of layers of neurons, types of connections between the layers (e.g., fully connected, convolutional, deconvolutional, etc.), the number of nodes within each layer, types of activation functions used in various layers/nodes of the network, types of loss functions used in training of the network, and so on. Generating models 101 may include setting (e.g., randomly) initial parameters (weights, biases) of various nodes of the networks. The generated models 101 may be trained using training data that may include training input(s) and corresponding target output(s).

For example, for training of speech recognition models, training inputs may include one or more digital sound recordings with utterances of words, phrases, and/or sentences that the MLM is being trained to recognize. Target outputs may include indications of whether the target words and phrases are present in the training inputs. Target outputs may also include transcriptions of the utterances, and so on. In some embodiments, target outputs may include identification of a speaker's intent. For example, a customer calling a food delivery service may express a limited number of intentions (to order food, to check on the status of the order, to cancel the order, etc.) but may do so in a practically unlimited number of ways. Whereas specific words and sentences uttered may not be of much significance, determination of the intent may be important. Accordingly, in such embodiments, target outputs may include a correct category of intent. Similarly, a target output for a training input that includes an utterance of a client calling a customer service phone may be both a transcription of the utterance as well as an indication of an emotional state of the client (e.g., angry, worried, satisfied, etc.). During training of models 101, a training software may identify patterns in training input(s) based on desired target output(s) and train the respective models 101 to perform desired tasks. Predictive utility of the identified patterns may subsequently be verified using additional training input/target output associations before being used, during the inference stage, in future processing of new speeches. For example, upon receiving a new voice message, a trained model 101 may be able to identify that the customer wishes to check on the status of a previously placed order, identify the name of the customer, the order number, and so on.

FIG. 1B illustrates an example inference server 102 capable of supporting multi-model, multi-processor inference and data processing, according to at least one embodiment. In at least one embodiment, inference engine 120 (including dataflow initialization engine 121 and dataflow management engine 122), inference backends 124, data processing backends 126, and/or other programs and applications may be executed multiple GPUs 110 (and/or other parallel processing units (PPUs) or accelerators, such as a deep learning accelerator, a data processing unit (DPU), etc.), and one or more CPUs 130. Although a single GPU 110 is depicted in FIG. 1B for the ease of viewing, the number of GPUs 110 need not be limited. In at least one embodiment, an individual GPU 110 includes multiple cores 111, some or all cores being capable of executing multiple threads 112. Some or all cores may run multiple threads 112 concurrently (e.g., in parallel). In at least one embodiment, threads 112 may have access to registers 113. Registers 113 may be thread-specific registers with access to a register restricted to a respective thread. Additionally, shared registers 114 may be accessed by one or more (e.g., all) threads of the core. In at least one embodiment, some or all cores 111 may include a scheduler 115 to distribute computational tasks and processes among different threads 112 of respective core 111. A dispatch unit 116 may implement scheduled tasks on appropriate threads using correct private registers 113 and shared registers 114. Inference server 102 may include input/output component(s) 138 to facilitate exchange of information with one or more users or developers.

In at least one embodiment, an individual GPU 110 may have a (high-speed) cache 118, access to which may be shared by multiple cores 111. Furthermore, inference server 102 may include a GPU memory 119 where GPU 110 may store intermediate and/or final results (outputs) of various computations performed by GPU 110. After completion of a particular task, GPU 110 (or CPU 130) may move the output to (main) memory 134. In at least one embodiment, CPU 130 may execute processes that involve serial computational tasks whereas GPU 110 may execute tasks (such as multiplication of inputs of a neural node by weights and adding biases) that are amenable to parallel processing. In at least one embodiment, inference engine 120 may determine which processes are to be executed on GPU 110 and which processes are to be executed on CPU 130.

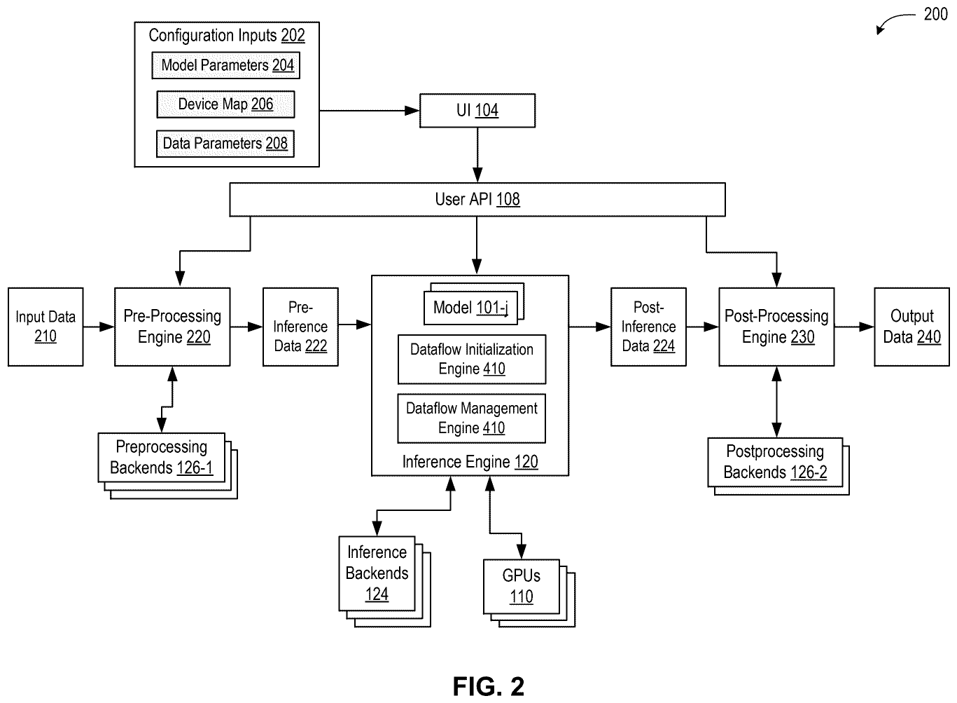

FIG. 2 illustrates a processing pipeline 200 for multi-model inference and data processing using multiple, heterogeneous GPUs, according to at least one embodiment. Processing pipeline 200 may include a user interface (UI) 104 that facilitates user-framework interactions. UI 104 may be or include a command line interface, a browser-based interface, a proprietary graphics interface, and/or any combination thereof. UI 104 may operate as a front-end in user-server interactions that are facilitated by user API 108. UI 104 may allow a user to input configuration inputs 202, which may be entered as part of high-level commands enabled by user API 108 and relayed to inference engine 120. Configuration inputs may include model parameters 204, device map 206, data parameters 208, and/or any other suitable parameters that may define configuration of the processing pipeline 200.

In some embodiments, model parameters 204 may identify memory locations where models 101-j are stored, names of the models, and/or other similar identifying information. Storage of models 101-j may be on a local user's computer, on a remote computer/server accessible to the user, on cloud, and/or the like. Models 101-j may be stored in a single storage location or in multiple locations, including multiple computers. Model parameters 204 may also control aspects of deployment and execution of models 101, e.g., identifying specific inference backends 124 to be used with various models 101-j, including but not limited to TensorFlow® backends, PyTorch® backends, TensorRT® backends, ONNX® backends, and/or the like.

In one illustrative example, model parameters 204 may be entered via UI 104 using the following command lines (or as equivalent graphics-selectable inputs):
Model-1: “/home/m1.onnx”
Model-2: “/home/m2.engine”
Model-3: “/office/m3.tf”
. . .
Model-N: “/home/mN.pt”
   indicating that model Model-1 is located in the/home folder and is an ONNX® model, models Model-2 and Model-N are also located in the same folder and are TensorRT® and PyTorch® models, respectively, model Model-3 is located in the/office folder and is a TensorFlow® model, and so on.

In those instances where a user does not specify, via model parameters 204, an inference backend for a particular model, inference engine 120 may deploy that particular model using a default inference backend. In some embodiments, the default inference backend may be the same for all models deployed and executed by inference engine 120. In some embodiments, the default inference backend may be dependent on a type of the model, e.g., different default inference backends may be set for medical imaging models, speech recognition models, text recognition models, physical/chemical sensor models, and so on. In some embodiments, default inference backends may be set by inference engine developers or administrators. In some embodiments, default inference backends may be modified by the user, e.g., by modifying a configuration file of inference engine 120.

Model parameters 204 may further indicate to inference engine 120 a number format to be used in inference computation, including but not limited to an integer number (e.g., INT8 or INT16), half-precision format (FP16), full-precision format (FP32), and/or the like.

Device map 206 may indicate to inference engine 120 a device map identifying the hardware platform to be used for execution of various models 101-j by the selected (or default) inference backends 124. For example, device map 206 may specify:
Model-1: “GPU-0”
Model-2: “GPU-2”
Model-3: “GPU-0”
Model-4: “GPU-2”
Model-5: “GPU-1”
Model-6: “GPU-0”
   indicating that Model-1, Model-3, and Model-6 are to be executed on GPU-0 (which may be the hub GPU), Model-2 and Model-4 are to be executed on GPU-2, and Model-5 is to be executed on GPU-1.

Yet another set of user configuration inputs may include data parameters 208 that indicate how data is to propagate through processing pipeline 200, which may include pre-processing engine 220, inference engine 120, post-processing engine 230, and/or any other modules and components as may be used for inference of input data 210. Data parameters 208 may inform processing pipeline 200 where input data 210 is stored. For example, data parameters 208 may specify:
“Model-1”: “/home/data_m1/”
“Model-2”: “/home/data_m2/”
“Model-3”: “/remote/data_m3/”
“Model-4”: “/home/data_m4/”
“Model-5”: “/remote/data_m5/”
“Model-6”: “/home/data_m6/”
   indicating that input into Model-1 is located in the/home/data_m1 folder, input into Model-2 is located in the/home/data_m2 folder, input into Model-3 is located in the/home/data_m3 folder, and so on.

Data parameters 208 may further specify how data is to be moved along processing pipeline 200. More specifically, data parameters 208 may specify where input data 210 is to be stored after operations of pre-processing engine 220, where the data is to be stored after inference engine 120 has performed inference processing of the data using models 101 (e.g., where the stored data may be accessed by a post-processing engine 230), and where final output data 240 is to be stored after post-processing by post-processing engine 230.

In one illustrative example, a set of data parameters 208 may include mapping of specific models to output data, which may include multiple outputs (e.g., multiple tensors) per model and may be entered as command lines (or as equivalent graphics-selectable inputs):
“Model-1”: [“Output_1_1”; “Output_1_2”; “Output_1_3”; “Output_1_4”]
“Model-2”: [“Output_2_1”; “Output_2_2”]
“Model-3”: [“Output_3_1”]
. . .
   indicating that model Model-1 is to generate output tensors Output_1_1, Output_1_2, Output_1_3, and Output_1_4, Model-2 is to generate output tensors Output_2_1 and Output_2_2, Model-3 is to generate output tensor Output_3_1, and so on.

In some embodiments, data parameters 208 may specify GPUs available for processing of input data 210, e.g.,
GPUs_visible: “GPU-0, GPU-1, GPU-2”
   indicating that three GPUs 110 (GPU-0, GPU-1, GPU-2) are available for processing of input data 210, or
GPUs_visible: “All”
   indicating that all system GPUs 110 are available for processing of input data 210.

In some embodiments, data parameters 208 may specify a GPU to be used as a hub GPU, e.g.,
Hub GPU: “GPU-0”
Auto_allocate GPUs: “False”
   indicating that GPU-0 is to be selected as the hub GPU, or
Auto_allocate_GPUs: “True”
   indicating that inference engine 120 is to allocate GPUs, including the hub GPU, automatically.

Although configuration inputs 202 in the above examples specify how inference processing is to be performed, similar commands and parameters may be used to specify performance of pre-processing and post-processing operations, e.g., which processing backends are to be deployed, what type of processing devices (GPUs, CPUs, etc.) are to be used, and/or the like.

Pre-processing engine 220, inference engine 120, and post-processing engine 230 may configure processing pipeline 200 as specified by the received configuration inputs 202. In particular, high-level commands used to input configuration inputs 202 may be converted into low-level commands by user API 108. Inference engine 120 may use the low-level commands to deploy inference backends 124 specified by configuration inputs 202. Additional low-level commands can be used by pre-processing engine 220 to deploy one or more preprocessing backends 126-1 and by post-processing engine 230 to deploy one or more post-processing backends 126-2, which may be default backends and/or backends selected via configuration inputs 202.

Pre-processing backends 126-1, inference backends 124, and post-processing backends 126-2 may execute various pipeline operations. For example, pre-processing backends 126-1 may transform input data 210 (that may include multiple data inputs for different models 101-j) into pre-inference data 222. Inference backends 124 may perform inference on pre-inference data 222 and output post-inference data 224. Postprocessing backends 126-2 may transform post inference data 224 into final output data 240.

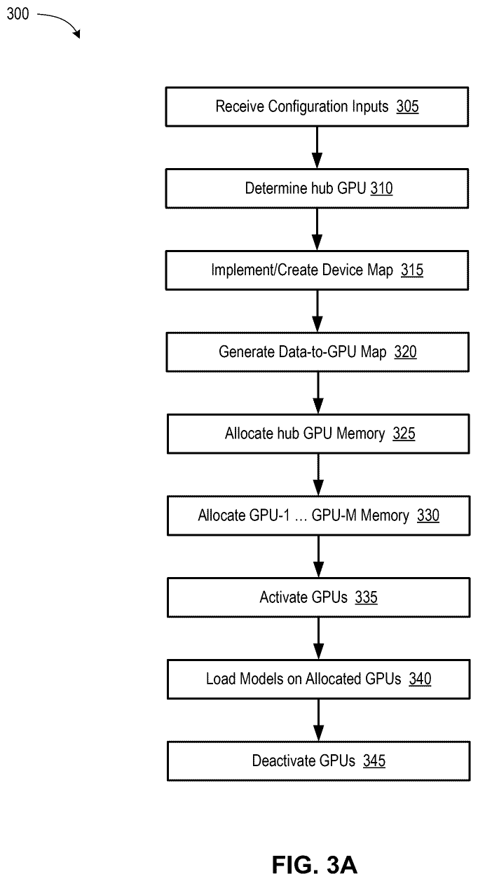

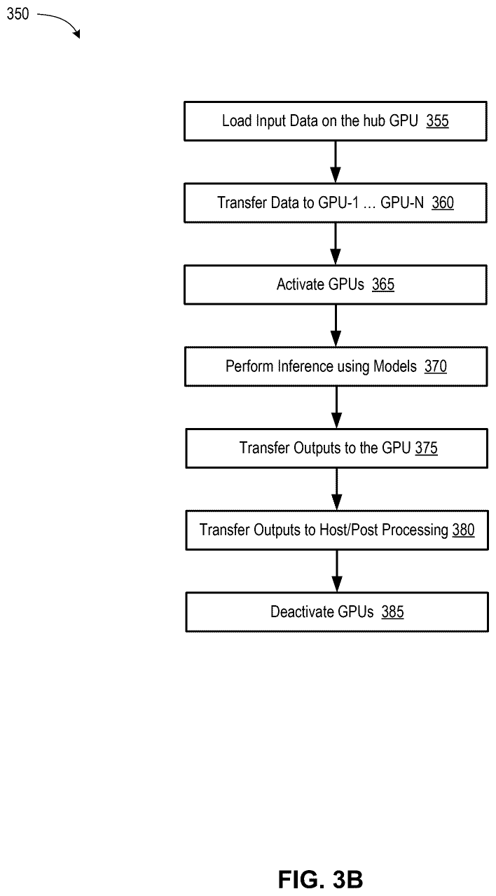

FIG. 3A illustrates operations 300 of an initialization stage of a multi-model multi-GPU inference pipeline, according to at least one embodiment. Although description of operations performed in conjunction with FIG. 3A (and, similarly, FIG. 3B) may refer to GPUs, for brevity and conciseness, it should be noted that one or more GPUs may be physical GPUs or virtual GPUs. Operations 300 may be performed by dataflow initialization engine 122 of inference engine 120 (with reference to FIG. 1A and FIG. 2). Operations 300 may include receiving configuration inputs (block 305), which may include model parameters 204, device map 206, data parameters 208, and the like. Operations 300 may include (block 310) determining a hub GPU. In some instances, the hub GPU may be specified in the received configuration inputs, e.g., as part of data parameters 208. In some instances, e.g., when a user has no preference or knowledge to select the hub GPU, inference engine may select, as a default, a GPU that has the most processing power, e.g., the most number of cores and/or the highest speed of processing (clock speed), the largest amount of GPU memory, or some combination thereof (e.g., using a metric in which the speed of processing and GPU memory are weighted using a set of empirically determined weights). Although any GPU-n may be selected as the hub GPU, for the sake of concreteness it is assumed herein that GPU-0 is selected as the hub GPU.

At block 315, inference engine 120 may implement the received device map 206, e.g., assign various MLMs, e.g., Model-1 . . . Model-N to available GPUs, e.g., GPU-0 . . . GPU-M. The number of models N and the number of GPUs M+1 need not be limited. In some instances, device map 206 may specify Models→GPUs assignment for all MLMs. In some instances, device map 206 may specify such assignment for only some or none of the MLMs. In such instances, e.g., when a user has no preference or knowledge to perform the assignment, inference engine 120 may use one or more algorithms to create the device map. For example, inference engine 120 may access a description of architecture of various models, including the number of neuron layers in the models, number of neurons in various layers, format of numbers used by each node (e.g., integer, floating point, etc.) and evaluate a number of processing operations (clock cycles) and amount of GPU memory to support deployment of the models. Inference engine 120 may then assign models to GPUs to minimize the amount of input and output data to be transferred between different GPUs. For example, inference engine 120 may assign models with the largest amounts of input data and/or output data to the hub GPU. The number of models assigned to the hub GPU (and, similarly, to other GPUs) may depend on the number of processing cores of the respective GPUs, such that the execution of the assigned models can be parallelized as much as possible. For example, if the hub GPU-0 is capable of parallel execution of the most data-demanding MLMs, e.g., Model-1, Model-3, and Model-6, the execution of Model-2 and other models can be assigned to other GPUs. In some implementations, inference engine 120 may assign models to GPUs in a balanced way, so that execution on different GPUs is completed at about the same time, to avoid bottleneck situations where one or more GPUs finish computations significantly later than other GPUs.

At block 320, inference engine 120 may generate a data-to-GPU map, which may include an input data map and an output data map. The input data map may specify memory addresses where outputs of the data pre-processing stage are stored, e.g., system memory, CPU cache, GPU memory of GPUs that performed the pre-processing, and/or the like. The input data map may further specify memory on GPU-0 . . . GPU-M where the received pre-processing outputs are to be stored. Similarly, the output data map may specify memory on various GPUs to store outputs of various models after execution. At block 325, inference engine 120 may allocate memory on the hub GPU. In some implementations, the memory allocated on the hub GPU may be sufficient to accommodate inputs and outputs of all models. For example, memory allocated on hub GPU may be sufficiently large to store all model inputs (and, similarly, all model outputs) concurrently. In some implementations, memory allocated on the hub GPU may only be sufficient to store all model inputs (and, similarly, all model outputs) sequentially. For example, memory allocated on the hub GPU may be sufficient to store inputs into Model-2, Model-4, and Model-6 and, after the inputs into these models have been transferred to other GPUs (e.g., GPU-1 and GPU-2), the vacated memory on the hub GPU may be used to store input into Model-1, Model-3 and Model-6 that are to be executed by the hub GPU. At block 330, a similar allocation of memory may be performed for other GPUs. For example, a sufficient memory space may be allocated on GPU-1 to store inputs and outputs into Model-5 and on GPU-2 to store inputs and outputs into Model-2 and Model-4. In some implementations, the allocated memory need not be large enough to store both inputs and outputs and may only be large enough to store the larger of the inputs and outputs, such that the outputs are be stored in the same memory space that is no longer occupied by the inputs that have already been processed.

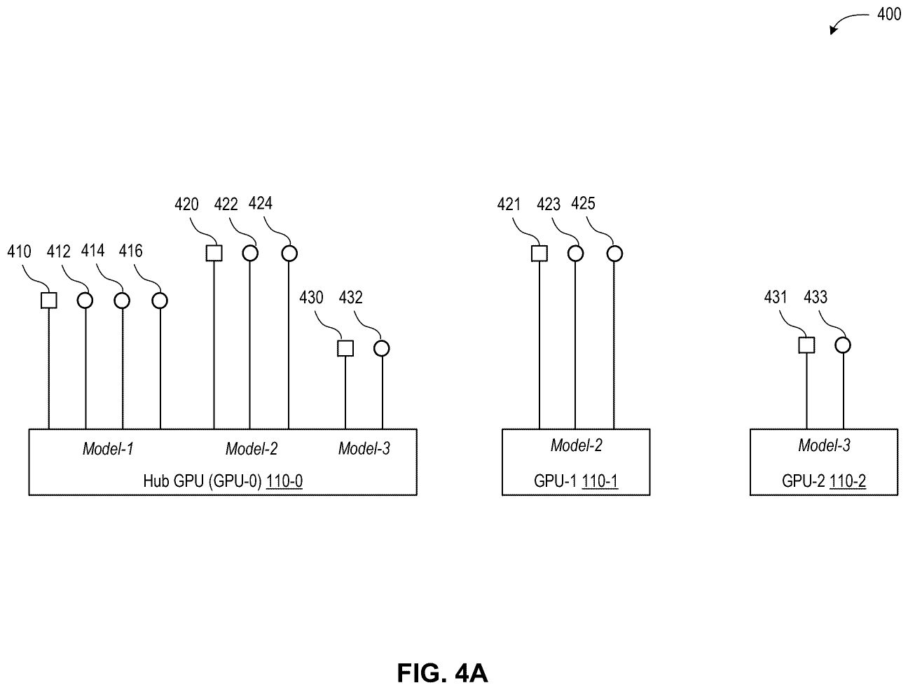

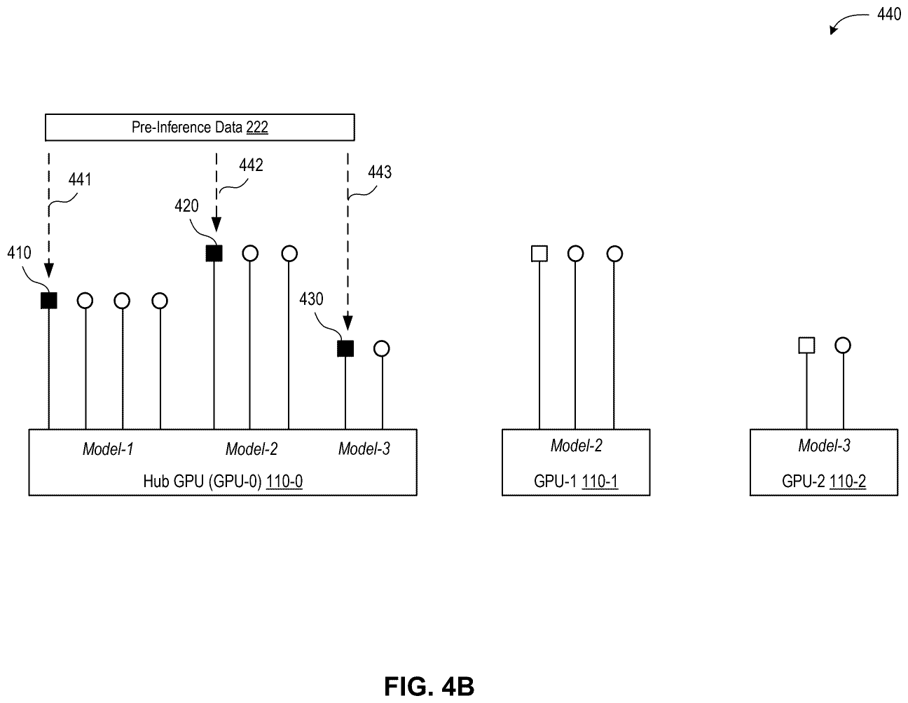

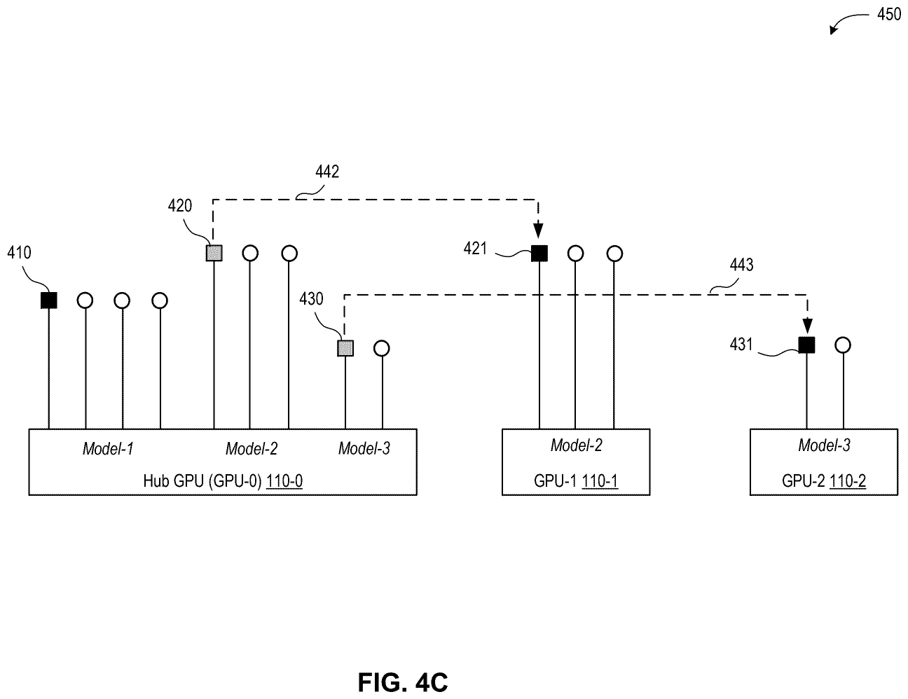

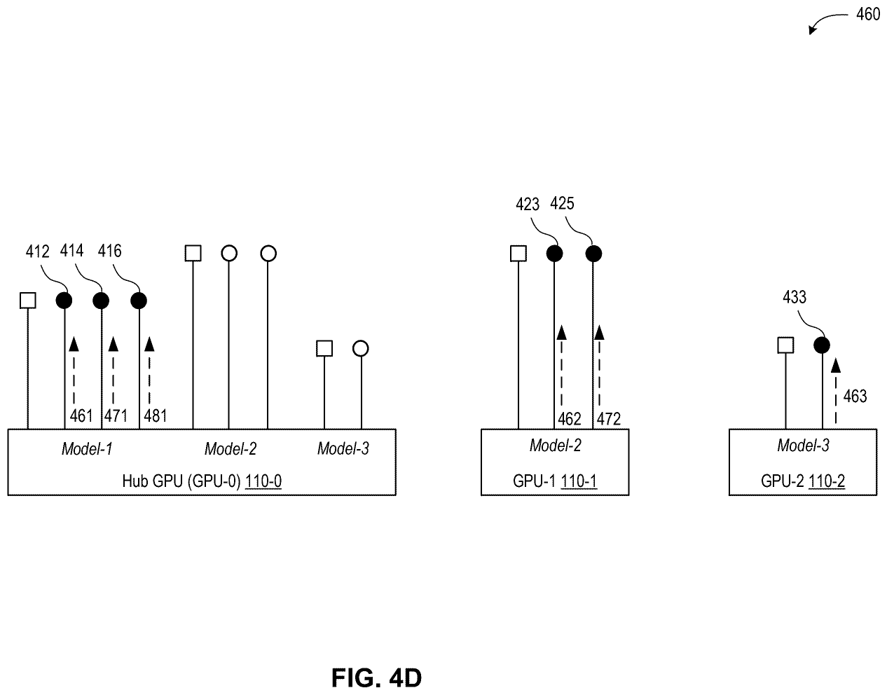

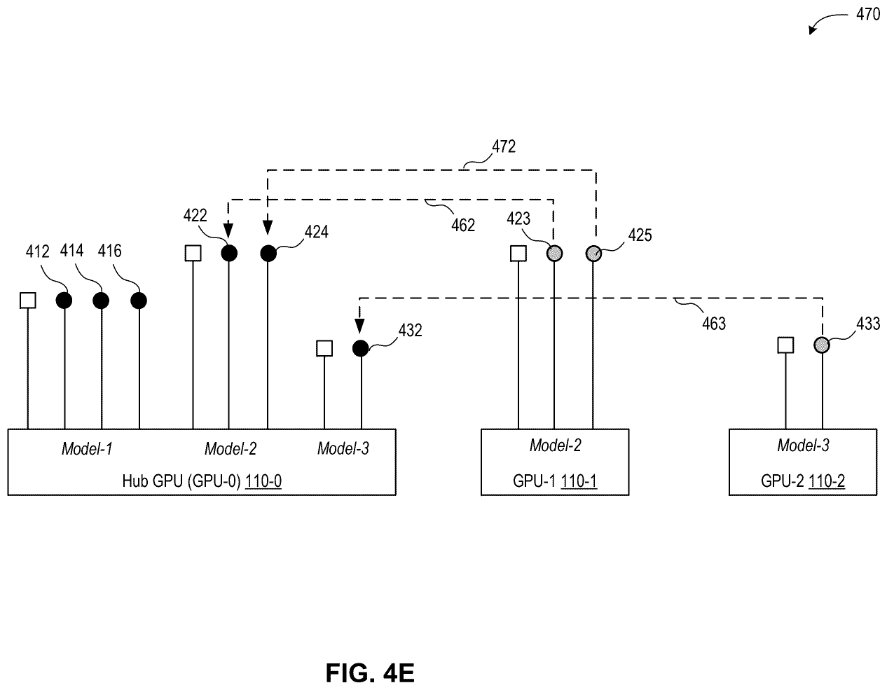

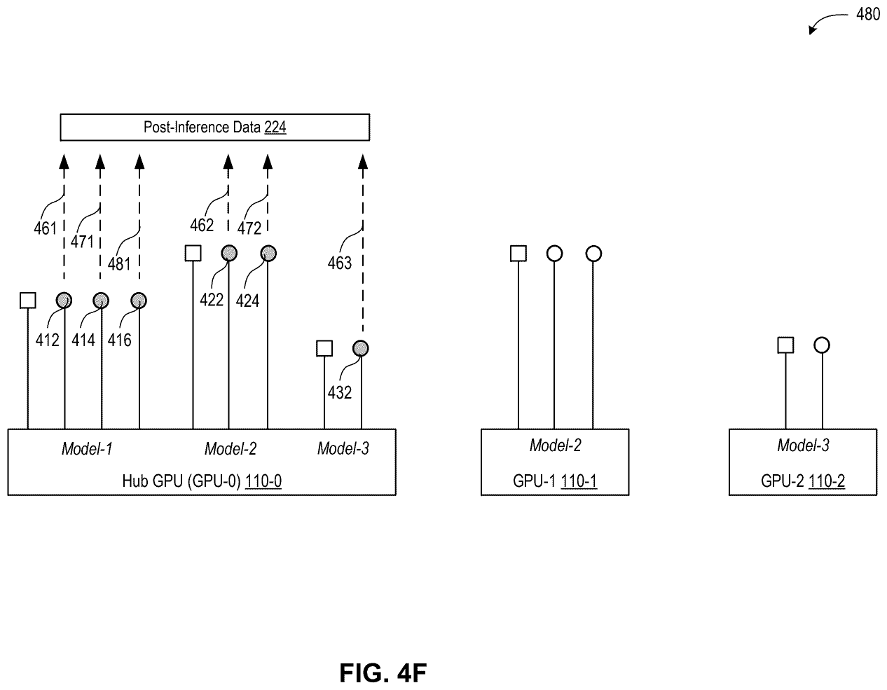

FIG. 4A illustrates schematically a process 400 of assigning models to GPUs and allocating memory spaces for various models, as part of an initialization stage of a multi-model multi-GPU inference, according to at least one embodiment. As an example, three GPUs are shown, hub GPU-0 (110-0), GPU-1 (110-1), and GPU-2 (110-2), assigned to execute Model-1, Model-2, and Model-3, respectively. Open squares indicate memory spaces (also referred to as buffers herein) allocated to store inputs into various models and open circles indicate memory spaces allocated to store respective outputs. Model-2 and Model-3, which are to be executed on GPU-1 and GPU-2, are allocated space in the memories of each of the hub GPU and respective GPU-1 and GPU-2 assigned to execute the respective models. For example, buffer 410 is allocated to store input data of Model-1 and buffers 412, 414, and 416 are allocated to store output data of Model-1. Similarly, on the hub GPU, buffer 420 is allocated to store input data of Model-2 and buffers 422 and 424 are allocated to store output data of Model-2. Additionally, on GPU-1, buffers 421, 423, and 425 are allocated to store input and output data of Model-2. Likewise, buffers 430 and 432 are allocated for Model-3 on the hub GPU and buffers 431 and 433 are allocated for the same Model-3 on GPU-2.

Referring again to FIG. 3A, operations 300 of the initialization stage may further include (at block 335) activation of GPUs, e.g., using a “cudaSetDevice( )” instruction, followed by loading various models to the memory of the allocated GPUs (block 340), and deactivation of the GPUs (block 345).

FIG. 3B illustrates operations 350 of an execution stage of the multi-model multi-GPU inference, according to at least one embodiment. Operations 350 may be performed by dataflow management engine 122 of inference engine 120 (with reference to FIG. 1A and FIG. 2). Operations 350 include loading (at block 355) input data on the hub GPU. Loading may be performed (sequentially or in parallel) for all models to be executed.

FIG. 4B illustrates schematically a process 440 of loading input data into a memory space allocated on a hub GPU, as part of an execution stage of a multi-model multi-GPU inference application pipeline, according to at least one embodiment. As illustrated, input data, e.g., pre-inference data 222 (with reference to FIG. 2) prepared using pre-processing engine 220, for various models is loaded into memory of the hub GPU. For example, input data 441 may be loaded into buffer 410 allocated to Model-1, input data 442 may be loaded into buffer 420 allocated to Model-2, and input data 443 may be loaded into buffer 430 allocated to Model-3. Buffers loaded with input data are indicated with black squares.

Referring again to FIG. 3B, operations 350 of the execution stage may include (at block 360) transferring the input data of models assigned for execution to GPU-1 . . . GPU-M to the corresponding GPUs. FIG. 4C illustrates schematically a process 450 of transferring input data into memory spaces of the assigned GPUs, according to at least one embodiment. As illustrated, input data 442 may be transferred from buffer 420 on the hub GPU to buffer 421 on GPU-1 and input data 443 may be transferred from buffer 430 on the hub GPU to buffer 431 on GPU-2.

Referring again to FIG. 3B, operations 350 of the execution stage may include (at block 365) activation of the GPUs. At block 360, various activated GPUs may perform inference processing (at block 370) of input data with models Model-1 . . . Model-N assigned to suitable GPUs. Execution of the models generates output data that is stored in assigned memory spaces on various GPUs. FIG. 4D illustrates schematically a process 460 of populating assigned memory spaces with outputs of models, according to at least one embodiment. As illustrated, output data 461, 471, and 481 generated by Model-1 may be stored, respectively, in buffers 412, 414, and 416 on the hub GPU, output data 462 and 472 generated by Model-2 may be stored, respectively, in buffers 423 and 425 on GPU-1, and output data 463 generated by Model-3 may be stored in buffer 433 on GPU-2.

Referring again to FIG. 3B, operations 350 of the execution stage may include (at block 375) transferring output data to the hub GPU. FIG. 4E illustrates schematically a process 470 of transferring outputs to the hub GPU, according to at least one embodiment. As illustrated, output data 462 and 472 generated using Model-2 and stored, respectively, in buffers 423 and 425 on GPU-1 may be transferred to buffers 422 and 424 on the hub GPU while output data 463 generated using Model-3 and stored in buffer 433 on GPU-2 may be transferred to buffers 4232 on the hub GPU.

Referring again to FIG. 3B, operations 350 of the execution stage may include (at block 380) transferring the output data to a host (e.g., CPU, operating system of the host computing device, and/or the like). FIG. 4F illustrates schematically a process 480 of transferring outputs from the hub GPU to a host, according to at least one embodiment. In some implementations, the output data, e.g., post-inference data 224 (with reference to FIG. 2), may be stored in the hub GPU, having been transferred to (or generated on) the hub GPU. As illustrated, the transferred post-inference data 224 may include output data 461, 471, and 481, generated using Model-1 and stored, respectively, in buffers 412, 414, and 416, output data 462 and 472 generated using Model-2 and stored, respectively, in buffers 422 and 424, and output data 463 generated using Model-3 and stored in buffer 432. Referring again to FIG. 3B, operations 350 of the execution stage may include deactivation of the GPUs (block 385). In those implementations, where inference processing with the MLMs is recurring, e.g., when processing a times series of input data, operations of blocks 355, 360, 370, 375, and 380 may be performed repeatedly while for each set of the input data.

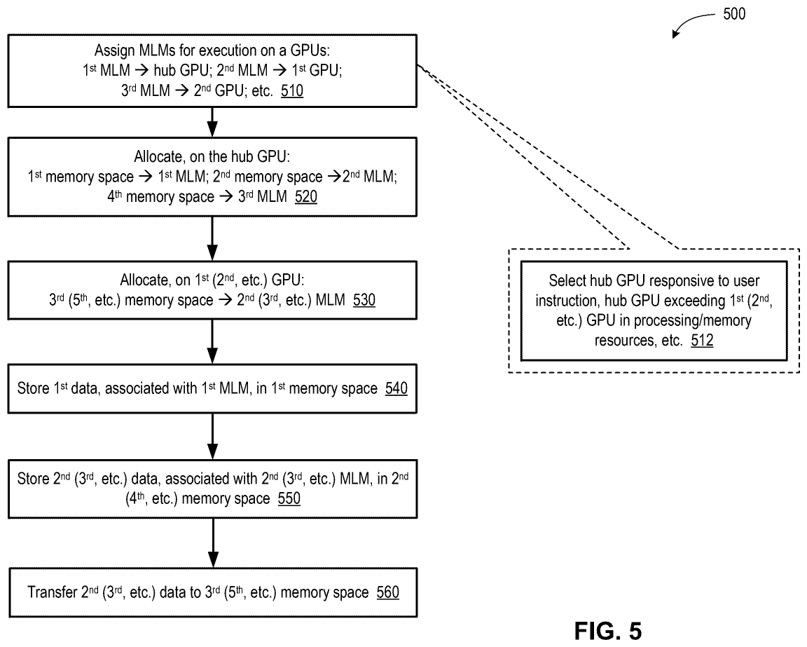

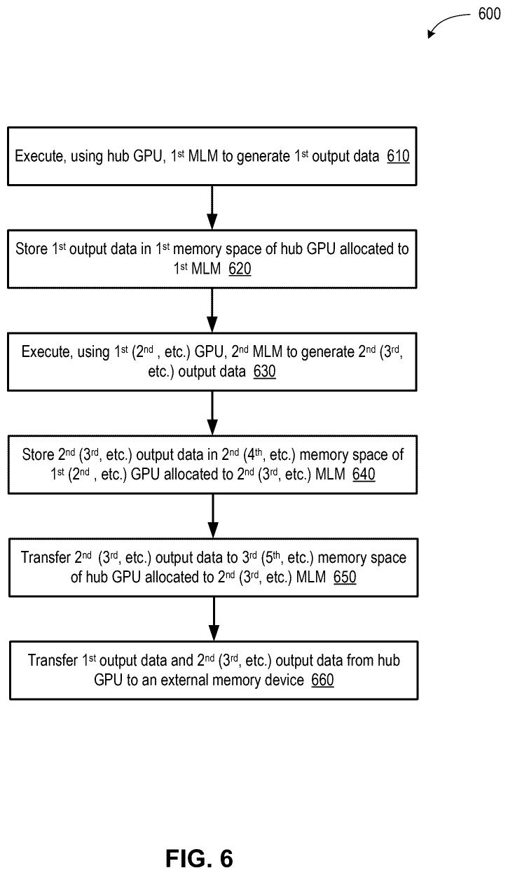

FIGS. 5 and 6 illustrate example methods 500 and 600 directed to deployment of multiple MLMs on systems having multiple processing units, e.g., GPUs or other processing units (such as DPUs, PPUs, and/or the like). Methods 500 and 600 may be used in any AI context of data processing, including inference of data, training of MLM models using training data, testing, validating, designing and/or developing MLMs, and/or the like. In at least one embodiment, methods 500 and/or 600 may be performed using processing units of inference server 102 of FIG. 1A and/or FIG. 1B. In some implementations, methods 500 and/or 600 may be deployed using processing pipeline 200 of FIG. 2. In at least one embodiment, processing units performing methods 500 and/or 600 may be executing instructions stored on a non-transient computer-readable storage media. In at least one embodiment, methods 500 and/or 600 may be performed using multiple processing threads (e.g., CPU threads and/or GPU threads), with individual threads executing one or more individual functions, routines, subroutines, or operations of the methods. In at least one embodiment, processing threads implementing any of methods 500 and/or 600 may be synchronized (e.g., using semaphores, critical sections, and/or other thread synchronization mechanisms). Alternatively, processing threads implementing any of methods 500 and/or 600 may be executed asynchronously with respect to each other. Various operations of any of methods 500 and/or 600 may be performed in a different order compared with the order shown in FIGS. 5 and 6. Some operations of any of methods 500 and/or 600 may be performed concurrently with other operations. In at least one embodiment, one or more operations shown in FIGS. 5 and 6 may not always be performed.

FIG. 5 is a flow diagram of an example method 500 of performing an initialization stage of a multi-model AI processing using multiple GPUs, according to at least one embodiment. At block 510, method 500 may include assigning a plurality of MLMs for execution on a plurality of GPUs. A first MLM of the plurality of MLMs may be assigned to a first (hub) GPU of the plurality of GPUs, a second MLM of the plurality of MLMs may be assigned to a second GPU of the plurality of GPUs, and/or the like. Terms such as “first,” “second,” “third,” and so on should be understood as mere identifiers that do not presuppose any temporal or semantic order. In some implementations, any number of additional MLM may be assigned to any one GPUs. For example, a third MLM of the plurality of MLMs may be assigned to a third GPU of the plurality of GPUs, but may alternatively be assigned to the hub GPU, the first GPU, or some other GPU.

In some implementations, as illustrated with the callout block 512, the first GPU may be selected from the plurality of GPUs to be a hub GPU responsive to a user instruction specifying the hub GPU, or a determination that the first GPU exceeds the first GPU in at least (i) a processing power or (ii) an amount of memory.

At block 520, method 500 may include allocating, on the first GPU, a first memory space to the first MLM and a second memory space to the second MLM. At block 530, method 500 may include allocating, on the second GPU, a third memory space to the second MLM, and/or the like.

At block 540, method 500 may continue with storing a first data in the first memory space. At block 550, method 500 may include storing a second data in the second memory space. The first (second, etc.) data may be associated with the first (second, etc.) MLM. In some implementations, the first (second, etc.) data may include parameters of the first (second, etc.) MLM, an input data into the first (second, etc.) MLM, and/or other data. The parameters of the first (second, etc.) MLM may include a map of neural connections, values of weights, biases, types of activation functions, and/or the like. In some implementations, the first (second, etc.) memory space may be allocated in view of a size of the first (second, etc.) data, a size of an (expected) output data of the first (second, etc.) MLM, a size of the first (second, etc.) MLM, e.g., an amount of memory used to store the first (second, etc.) MLM, and/or the like.

At block 560, method 500 may include transferring the second data (e.g., from the second memory space) to the third memory space. Similarly, data for any additional MLM may be handled by the hub GPU and transferred to a target GPU that is to execute the respective model. For example, at block 510, a third MLM of the plurality of MLMs may be assigned to a third GPU of the plurality of GPUs; at block 520, a fourth memory may be allocated, on the hub GPU, to the third MLM; at block 530, a fifth memory space may be allocated, on the third GPU, to the third MLM; at block 540, a third data, associated with the third MLM, may be stored in the fourth memory space; and at block 550, the third data may be transferred (e.g., from the fourth memory space) to the fifth memory space.

In some implementations, the hub GPU and one or more other GPUs are communicatively coupled by a Peripheral Component Interconnect Express (PCIe) connection or a similar connection. In one or more implementations, the hub GPU and one or more other GPUs may be located in the same processing node or GPU cluster of a datacenter.

In some implementations, assigning the plurality of MLMs for execution on the plurality GPUs may be responsive to a user instruction explicitly specifying the assigning, or may be responsive to a first (second, etc.) computational complexity of the first MLM, a second computational complexity of the second MLM, a first size of the first data, or a second size of the second data, and/or the like.

Handling of data during MLM execution may be performed according to method 600 described in conjunction with FIG. 6 below.

FIG. 6 is a flow diagram of an example method 600 of performing an execution stage of a multi-model AI processing using multiple GPUs, according to at least one embodiment. At block 610, method 600 may include executing, using a first GPU of a plurality of GPUs, a first machine learning model (MLM) of a plurality of MLMs to generate a first output data. In one or more embodiments, the first GPU is designated as a hub GPU for an AI workload, and used to facilitate the transfer of data—e.g., data corresponding to an input or parameters for an MLM(s), or an output generated using the MLM(s)—between one or more other GPUs assigned to perform or execute the AI workload.

At block 620, method 600 may continue with storing the first output data in a first memory space of the first GPU, the first memory space being allocated to the first MLM. At block 630, method 600 may include executing, using a second GPU of the plurality of GPUs, a second MLM of the plurality of MLMs to generate a second output data. In some implementations, prior to execution of the first MLM, the first memory space may store a first input data associated with the first MLM.

At block 640, method 600 may include storing the second output data in a second memory space of the second GPU, the second memory space being allocated to the second MLM. At block 650, method 600 may continue with transferring the second output data from the second memory space to a third memory space of the first GPU, the third memory space being allocated to the second MLM.

In some implementations, prior to execution of the second MLM (using the second GPU), method 600 may include storing a second input data, associated with the second MLM, in the third memory space (of the hub GPU) and transferring the second input data to the second memory space (of the second GPU).

Output data generated by any additional MLM may be handled in a similar way. For example, at block 630, a third MLM may be executed using a third GPU to generate a third output data. At block 640, the third output data may be stored in a fourth memory space of the third GPU, the fourth memory space being allocated to the third MLM. At block 650, the third output data may be transferred from the fourth memory space to a fifth memory space of the first GPU, the fifth memory space being allocated to the third MLM.

At block 660, method 600 may include transferring the first output data and the second (third, etc.) output data from the hub GPU to a memory device external to the hub GPU, e.g., to a processing unit that performs post-processing of the output data.

### Inference and Training Logic

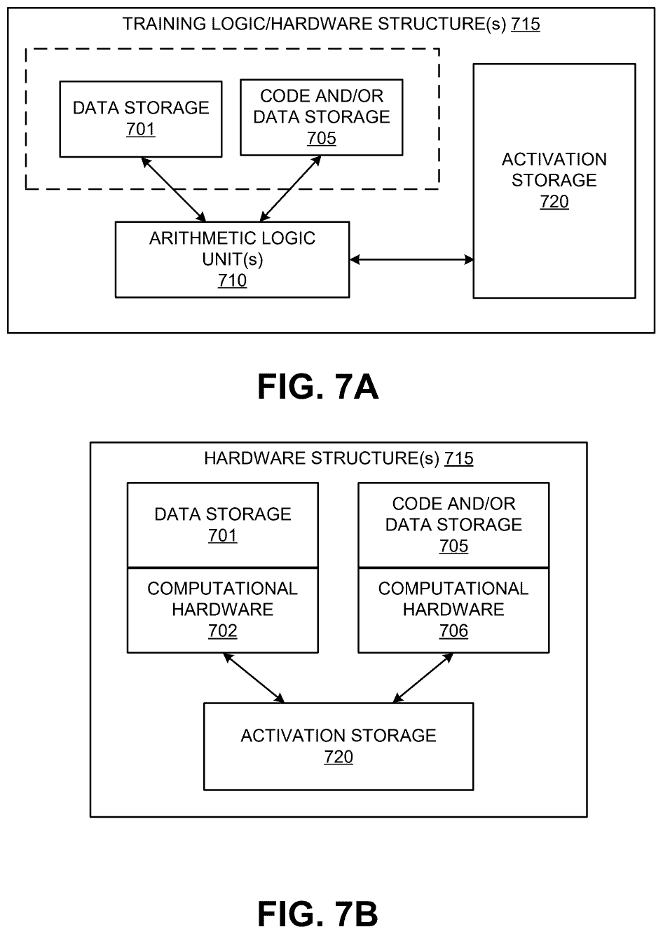

FIG. 7A illustrates inference and/or training logic 715 used to perform inference and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inference in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inference using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inference functions being performed, batch size of data used in inference and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inference in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inference using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inference functions being performed, batch size of data used in inference and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inference and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inference functions being performed, batch size of data used in inference and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware, data processing unit (“DPU”) hardware, or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware, data processing unit (DPU) hardware, or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

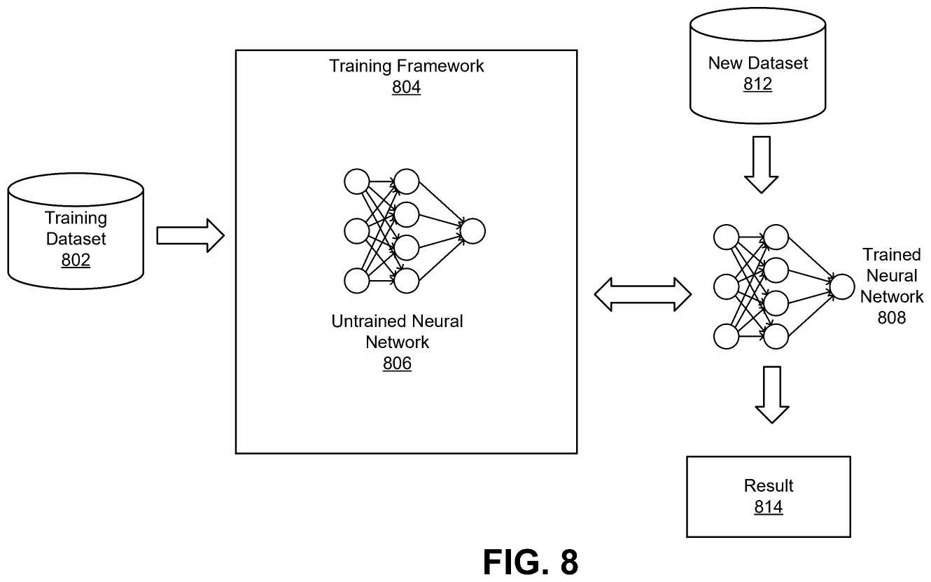

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

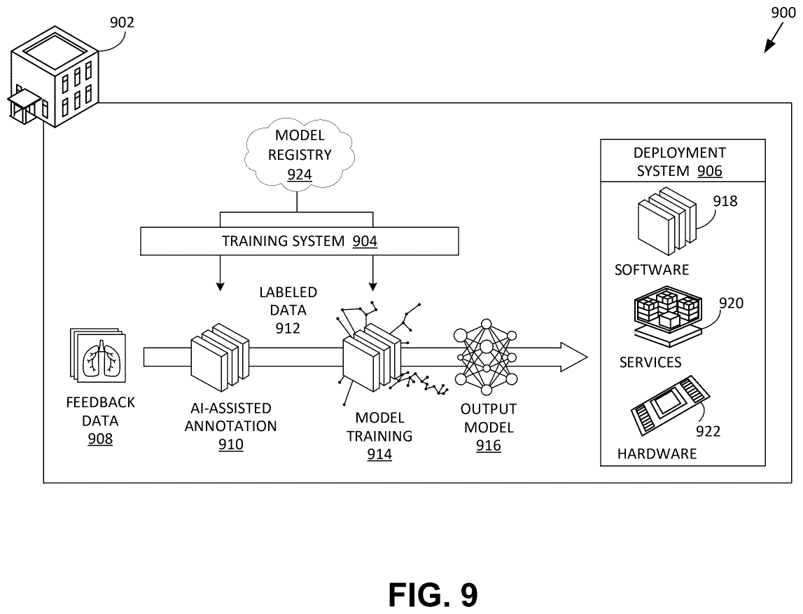

With reference to FIG. 9, FIG. 9 is an example data flow diagram for a process 900 of generating and deploying a processing and inference pipeline, according to at least one embodiment. In at least one embodiment, process 900 may be deployed to perform game name recognition analysis and inference on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some of applications used in advanced processing and inference pipelines may use machine learning models or other AI to perform one or more processing steps. In at least one embodiment, machine learning models may be trained at facility 902 using feedback data 908 (such as feedback data) stored at facility 902 or feedback data 908 from another facility or facilities, or a combination thereof. In at least one embodiment, training system 904 may be used to provide applications, services, and/or other resources for generating working, deployable machine learning models for deployment system 906.

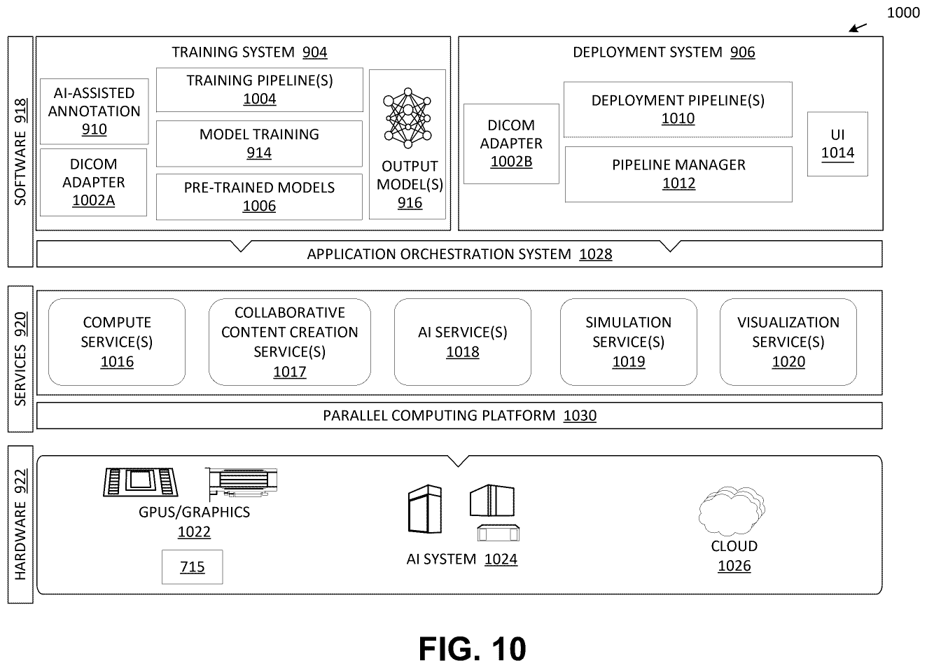

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inference pipeline (e.g., inference, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inference pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inference tasks or other processing tasks of a pipeline to prepare an output data for a next application and/or to prepare output data for transmission and/or use by a user (e.g., as a response to an inference request). In at least one embodiment, inference tasks may be performed by one or more machine learning models, such as trained or deployed neural networks, which may include output models 916 of training system 904.

In at least one embodiment, tasks of data processing pipeline may be encapsulated in a container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers may develop, publish, and store applications (e.g., as containers) for performing processing and/or inference on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., system 1000 of FIG. 10). In at least one embodiment, once validated by system 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1000 of FIG. 10). In at least one embodiment, completed and validated applications or containers may be stored in a container registry and associated machine learning models may be stored in model registry 924. In at least one embodiment, a requesting entity—who provides an inference or image processing request—may browse a container registry and/or model registry 924 for an application, container, dataset, machine learning model, etc., select a desired combination of elements for inclusion in data processing pipeline, and submit an processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel (e.g., using a parallel computing platform 1030 (FIG. 10)). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inference pipeline may be streamlined because each application may call upon a same inference service to perform one or more inference tasks.

In at least one embodiment, hardware 922 may include GPUs, CPUs, DPUs, graphics cards, an AI/deep learning system (e.g., an AI supercomputer, such as NVIDIA's DGX supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, as non-limiting examples. In at least one embodiment, at least some of computing environment of deployment system 906 and/or training system 904 may be executed in a datacenter one or more supercomputers or high performance computing systems, with GPU optimized software (e.g., hardware and software combination of NVIDIA's DGX system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example system 1000 for generating and deploying a deployment pipeline, according to at least one embodiment. In at least one embodiment, system 1000 may be used to implement process 900 of FIG. 9 and/or other processes including advanced processing and inference pipelines. In at least one embodiment, system 1000 may include training system 904 and deployment system 906. In at least one embodiment, training system 904 and deployment system 906 may be implemented using software 918, services 920, and/or hardware 922, as described herein.

In at least one embodiment, system 1000 (e.g., training system 904 and/or deployment system 906) may implemented in a cloud computing environment (e.g., using cloud 1026). In at least one embodiment, system 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1000, may be restricted to a set of public IPs that have been vetted or authorized for interaction.

In at least one embodiment, various components of system 1000 may communicate between and among one another using any of a variety of different network types, including but not limited to local area networks (LANs) and/or wide area networks (WANs) via wired and/or wireless communication protocols. In at least one embodiment, communication between facilities and components of system 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004 similar to a first example described with respect to FIG. 9 may be used for a first machine learning model, training pipeline 1004 similar to a second example described with respect to FIG. 9 may be used for a second machine learning model, and training pipeline 1004 similar to a third example described with respect to FIG. 9 may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment or embodiment. In at least one embodiment, and without limitation, machine learning models used by system 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of AI-assisted annotation included in training pipelines 1004. In at least one embodiment, system 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s) (e.g., facility 902). In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types)—including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface 1014 (e.g., a graphical user interface, a web interface, etc.) that may be used to select applications for inclusion in deployment pipeline(s) 1010, arrange applications, modify or change applications or parameters or constructs thereof, use and interact with deployment pipeline(s) 1010 during set-up and/or deployment, and/or to otherwise interact with deployment system 906. In at least one embodiment, although not illustrated with respect to training system 904, user interface 1014 (or a different user interface) may be used for selecting models for use in deployment system 906, for selecting models for training, or retraining, in training system 904, and/or for otherwise interacting with training system 904.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1028) may determine resource availability and distribution based on constraints imposed on a system (e.g., user constraints), such as quality of service (QOS), urgency of need for data outputs (e.g., to determine whether to execute real-time processing or delayed processing), etc.

In at least one embodiment, services 920 leveraged by and shared by applications or containers in deployment system 906 may include compute services 1016, AI services 1018, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inference services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inference tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inference using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inference tasks of AI services 1018.

In at least one embodiment, shared storage may be mounted to AI services 1018 within system 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inference may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT less than one minute) priority while others may have lower priority (e.g., TAT less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inference on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA and/or QUADRO GPUs) may include any number of GPUs that may be used for executing processing tasks of compute services 1016, AI services 1018, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inference (e.g., to execute machine learning models). In at least one embodiment, cloud 1026, AI system 1024, and/or other components of system 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inference—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inference, deep learning, machine learning, and/or other artificial intelligence tasks. In at least one embodiment, AI system 1024 (e.g., NVIDIA's DGX) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of system 1000.

In at least one embodiment, cloud 1026 may include a GPU-accelerated infrastructure (e.g., NVIDIA's NGC) that may provide a GPU-optimized platform for executing processing tasks of system 1000. In at least one embodiment, cloud 1026 may include an AI system(s) 1024 for performing one or more of AI-based tasks of system 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may tasked with executing at least some of services 920 of system 1000, including compute services 1016, AI services 1018, and/or visualization services 1020, as described herein. In at least one embodiment, cloud 1026 may perform small and large batch inference (e.g., executing NVIDIA's TENSOR RT), provide an accelerated parallel computing API and platform 1030 (e.g., NVIDIA's CUDA), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1000.

In at least one embodiment, in an effort to preserve patient confidentiality (e.g., where patient data or records are to be used off-premises), cloud 1026 may include a registry—such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) and/or a data processing unit (“DPU”)—potentially in conjunction with a GPU)—executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
assigning a plurality of machine learning models (MLMs) for execution of a workload using a plurality of graphics processing units (GPUs), wherein a first MLM of the plurality of MLMs is assigned to a first GPU of the plurality of GPUs, and wherein a second MLM of the plurality of MLMs is assigned to a second GPU of the plurality of GPUs;
allocating a first memory space corresponding to the first GPU to the first MLM and a second memory space corresponding to the first GPU to the second MLM;
allocating a third memory space corresponding to the second GPU to the second MLM;
storing a first data, associated with the first MLM, in the first memory space;
storing a second data, associated with the second MLM, in the second memory space; and
transferring the second data from the second memory space to the third memory space.

2. The method of claim 1, wherein the first GPU is selected to be a hub GPU from the plurality of GPUs responsive to at least one of:
a user instruction specifying the first GPU, or
a determination that the first GPU exceeds the second GPU in at least (i) a processing power or (ii) an amount of memory.

3. The method of claim 1, wherein assigning the plurality of MLMs for execution on the plurality of GPUs is responsive at least to:
a user instruction specifying the assigning,
a first computational complexity of the first MLM,
a second computational complexity of the second MLM,
a first size of the first data, or
a second size of the second data.

4. The method of claim 1, wherein the first data comprises:
one or more parameters of the first MLM, and
an input data into the first MLM; and
wherein the first memory space is allocated in view of at least:
a size of the first data, and
a size of an output data of the first MLM.

5. The method of claim 1, wherein a third MLM of the plurality of MLMs is assigned to a third GPU of the plurality of GPUs, and wherein the method further comprises:
allocating a fourth memory space corresponding to the first GPU to the third MLM;
allocating, a fifth memory space corresponding to the third GPU to the third MLM;
storing a third data, associated with the third MLM, in the fourth memory space; and
transferring the third data from the fourth memory space to the fifth memory space.

6. The method of claim 1, wherein the first GPU and the second GPU are communicatively coupled using a Peripheral Component Interconnect Express (PCIe) connection.

7. The method of claim 1, further comprising:
executing, using the first GPU, the first MLM to generate a first output data;
storing the first output data in the first memory space;
executing, using the second GPU, the second MLM to generate a second output data;
storing the second output data in the third memory space; and
transferring the second output data from the third memory space to the second memory space.

8. The method of claim 7, further comprising:
transferring the first output data and the second output data from the first GPU to a memory device external to the first GPU.

9. A method comprising:
executing, using a first GPU of a plurality of GPUs, a first machine learning model (MLM) of a plurality of MLMs to generate a first output data;
storing the first output data in a first memory space of the first GPU, wherein the first memory space is allocated to the first MLM;
executing, using a second GPU of the plurality of GPUs, a second MLM of the plurality of MLMs to generate a second output data;
storing the second output data in a second memory space of the second GPU, wherein the second memory space is allocated to the second MLM; and
transferring the second output data from the second memory space to a third memory space of the first GPU, wherein the third memory space is allocated to the second MLM.

10. The method of claim 9, further comprising:
transferring the first output data and the second output data from the first GPU to a memory device external to the first GPU.

11. The method of claim 9, further comprising:
executing, using a third GPU of the plurality of GPUs, a third MLM of the plurality of MLMs to generate a third output data;
storing the third output data in a fourth memory space of the third GPU, wherein the fourth memory space is allocated to the third MLM; and
transferring the third output data from the fourth memory space to a fifth memory space of the first GPU, wherein the fifth memory space is allocated to the third MLM.

12. The method of claim 9, wherein, prior to execution of the first MLM, the first memory space stores a first input data associated with the first MLM, the method further comprising:
prior to execution of the second MLM:
storing a second input data, associated with the second MLM, in the third memory space; and
transferring the second input data from the third memory space to the second memory space.

13. The method of claim 12, wherein the first memory space is allocated in view of at least:
a size of the first input data, or
a size of the first output data.

14. The method of claim 9, wherein the first GPU is selected from the plurality of GPUs responsive to at least one of:
a user instruction specifying the first GPU, or
a determination that the first GPU exceeds the second GPU in at least (i) a processing power or (ii) an amount of memory.

15. The method of claim 9, wherein the first MLM is assigned for execution on the first GPU responsive at least to:
a user instruction,
a first computational complexity of the first MLM, or
a first size of the first data.

16. A system comprising:
one or more processing units to:
assign a plurality of machine learning models (MLMs) for execution on a plurality of graphics processing units (GPUs), wherein a first MLM of the plurality of MLMs is assigned to a first GPU of the plurality of GPUs, and wherein a second MLM of the plurality of MLMs is assigned to a second GPU of the plurality of GPUs;
allocate, using memory corresponding to the first GPU, a first memory space to the first MLM and a second memory space to the second MLM;
allocate, using memory corresponding to the second GPU, a third memory space to the second MLM;
store a first input data, associated with the first MLM, in the first memory space;
store a second data, associated with the second MLM, in the second memory space; and
transfer the second data from the second memory space to the third memory space.

17. The system of claim 16, wherein the first GPU is selected from the plurality of GPUs responsive to at least one of:
a user instruction specifying the first GPU, or
a determination that the first GPU exceeds the second GPU in at least (i) a processing power or (ii) an amount of memory; and
wherein the plurality of MLMs is assigned for execution on the plurality of GPUs responsive at least to:
a user instruction specifying the assigning,
a first computational complexity of the first MLM,
a second computational complexity of the second MLM,
a first size of the first data, or
a second size of the second data.

18. The system of claim 16, wherein the first data comprises:
parameters of the first MLM, and
an input data into the first MLM; and
wherein the first memory space is allocated in view of at least:
a size of the first data, and
a size of an output data of the first MLM.

19. The system of claim 16, wherein the one or more processing units are to:
execute, using the first GPU, the first MLM to generate a first output data;
store the first output data in the first memory space;
execute, using the second GPU, the second MLM to generate a second output data;
store the second output data in the third memory space; and
transfer the second output data from the third memory space to the second memory space.

20. The system of claim 16, wherein the system is comprised in at least one of:
an in-vehicle infotainment system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system for performing one or more generative AI operations;
a system implementing one or more large language models (LLMs);
a system implementing one or more visual language models (VLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.
